(19) United States
(12) Patent Application Publication
(10) Pub. No.: US 2019/0300780 A1
(43) Pub. Date: Oct. 3, 2019

(54) NANOPARTICLE GEL SYSTEMS FOR TREATING CARBONATE FORMATIONS

(71) Applicant: HALLIBURTON ENERGY SERVICES, INC., HOUSTON, TX (US)

(72) Inventors: Enrique Antonio Reyes, Tomball, TX (US); Dipti Singh, Kingwood, TX (US)

(21) Appl. No.: 16/302,855

(22) PCT Filed: Aug. 1, 2016
(86) PCT No.: PCT/US2016/045000

§ 371 Date: Nov. 19, 2018

(51) Int. Cl. C09K 8/68; C09K 8/66; C09K 8/80; E21B 43/267; C09K 8/92; C09K 8/90; C09K 8/84

(52) U.S. Cl. CPC C09K 8/685; C09K 8/665; C09K 8/80; E21B 43/267; B82Y 40/00; C09K 8/90; C09K 8/845; C09K 2208/10; C09K 8/92

(57) ABSTRACT

Methods of treating a carbonate formation are provided. The methods include introducing a nanoparticle gel system into the carbonate formation at a rate and pressure sufficient to create or enhance at least one fracture in the carbonate formation. The nanoparticle gel system includes a gelling agent, a nanoparticle-size clay, and a proppant. The methods further include allowing a portion of the proppant to deposit in the at least one fracture, pumping an acidic fluid into the carbonate formation, and allowing a portion of the acidic fluid to at least partially reduce a viscosity of the nanoparticle gel system and to react with the carbonate formation.

### BACKGROUND

The present invention relates generally to stimulating carbonate formations. In particular, the present invention relates to methods of treating a carbonate formation by fracturing the formation with a nanoparticle gel system that includes a gelling agent, a nanoparticle-size clay, and a proppant, and acidizing the formation.

Hydraulic fracturing is a primary tool for improving well productivity by placing or extending channels from the wellbore to the reservoir. In hydraulic fracturing, a viscous gelled aqueous fluid, referred to as a fracturing fluid, is pumped through the well bore into a subterranean zone to be stimulated at a rate and pressure such that fractures are formed and extended into the subterranean zone. The fracturing fluid also carries particulate solids, referred to as proppant particles, into the fractures. The proppant particles are suspended in the viscous gelled aqueous fracturing fluid so that the proppant particles are carried into the fractures. The viscous fracturing fluid is then broken by a viscosity breaker so that the proppant particles are deposited in the fractures and the fracturing fluid is removed from the subterranean zone.

The development of suitable fracturing fluids is a complex art because the fluids must simultaneously meet a number of conditions. For example, they must be stable at high temperatures, high pump rates, and shear rates, which may cause the fluids to degrade and prematurely settle out the proppant before the fracturing operation is complete. Various fluids have been developed, but most commercially used fracturing fluids are aqueous based liquids which have either been gelled or foamed. When the fluids are gelled, typically a polymeric gelling agent, such as a solvable polysaccharide is used, which may or may not be cross-linked. The thickened or gelled fluid helps keep the proppants within the fluid during the fracturing operation.

Acidizing is commonly performed in sandstone and carbonate formations. In carbonate formations, the goal is usually to have the acid dissolve the carbonate rock to form highly conductive fluid flow channels in the formation rock. In acidizing a carbonate formation, calcium and magnesium carbonates of the rock can be dissolved with acid. A reaction between an acid and the minerals calcite (CaCO₃) or dolomite (CaMg(CO₃)₂) can enhance the fluid flow properties of the rock.

Because of the complexity involved in stimulating carbonate formations, there is a continuing need for improved fracturing fluids and methods of fracturing and acidizing the formations.

### BRIEF DESCRIPTION OF THE DRAWINGS

The following figures are included to illustrate certain aspects of the present invention, and should not be viewed as an exclusive embodiment. The subject matter disclosed is capable of considerable modification, alteration, and equivalents in form and function, as will occur to those of ordinary skill in the art and having the benefit of this disclosure.

FIG. 1 illustrates a land-based drilling and production system;

FIG. 2 illustrates how a carbonate formation is treated with a nanoparticle gel system and acidic fluid according to embodiments of the present invention;

FIG. 3 depicts a method of treating a carbonate formation according to embodiments of the present invention;

FIG. 4 illustrates proppant transport measurement of a nanoparticle gel system at 250° F. according to embodiments of the present invention; and

FIG. 5 illustrates proppant transport measurement of a nanoparticle gel system at 300° F. according to embodiments of the present invention.

### DETAILED DESCRIPTION

According to several exemplary embodiments, the methods of the present invention utilize a nanoparticle gel system as a fracturing fluid in combination with an acidic fluid (e.g., a fluid having a pH of less than about 4) to fracture and acidize a carbonate formation. The nanoparticle gel system includes a gelling agent, a nanoparticle-size clay, and a proppant. According to several exemplary embodiments, the nanoparticle gel system is a fluid capable of fracturing a carbonate formation and distributing proppant in the formation. According to several exemplary embodiments, the nanoparticle gel system simultaneously provides proppant suspension and fluid loss control up to about 400° F. by virtue of film formation. According to several exemplary embodiments, the nanoparticle gel system is stable up to about 400° F. due to the presence of the nanoparticle-size clay, and can carry or suspend proppant.

According to several exemplary embodiments, the acidic fluid is used to break down or degrade the gelling agent in the nanoparticle gel system, leaving the proppant and/or nanoparticle-size clay behind in the fractures. According to several exemplary embodiments, the proppant and nanoparticle-size clay agglomerate or integrate into particulate masses that prevent the closure of fractures in the carbonate formation and/or serve as diverting agents. According to several exemplary embodiments, the acidic fluid reacts with the fractured carbonate formation to dissolve it, etch it, and generate conductive pathways on the fractured carbonate formation while proppant and/or nanoparticle-size clay clusters remain to prevent closure of the fractures in the formation. According to several exemplary embodiments, the acidic fluid enhances fluid conductivity of the carbonate formation.

According to several exemplary embodiments, the gelling agent is cross-linked. According to several exemplary embodiments, the nanoparticle-size clay provides static stability to the nanoparticle gel system up to temperatures of about 300° F., while cross-linking the gelling agent provides dynamic stability to the nanoparticle gel system. In other words, the nanoparticle-size clay helps to maintain the viscosity of the nanoparticle gel system when it is stationary, while the cross-linking helps to maintain the viscosity of the nanoparticle gel system when it is under shear.

According to several exemplary embodiments, a method of treating a carbonate formation is provided. The method includes introducing a nanoparticle gel system including a gelling agent, a nanoparticle-size clay, and a proppant into the carbonate formation at a rate and pressure sufficient to create or enhance at least one fracture in the carbonate formation; allowing a portion of the proppant to deposit in the at least one fracture; pumping an acidic fluid into the carbonate formation; and allowing a portion of the acidic fluid to at least partially reduce a viscosity of the nanoparticle gel system and to create conductive channels in the carbonate formation. According to several exemplary embodiments, a pump is used to introduce the nanoparticle gel system into the carbonate formation.

According to several exemplary embodiments, the gelling agent is present in the nanoparticle gel system in an amount of about 0.1 percent to about 2.0 percent by weight of the nanoparticle gel system. For example, the gelling agent may be present in an amount of about 1.2 percent by weight or about 0.5 percent by weight of the nanoparticle gel system. According to several exemplary embodiments, the amount of gelling agent may go up to about 10 percent by weight of the nanoparticle gel system when hectorite is not used as the nanoparticle-size clay. According to several exemplary embodiments, the gelling agent includes one or more cellulose derivatives, guar gum, or guar derivatives. According to several exemplary embodiments, the cellulose derivatives comprise carboxymethylcellulose.

According to several exemplary embodiments, the gelling agent is cross-linked. According to several exemplary embodiments, the nanoparticle gel system further includes a cross-linking agent. According to several exemplary embodiments, the cross-linking agent comprises a metal cross-linking agent.

According to several exemplary embodiments, the nanoparticle-size clay is present in the nanoparticle gel system in an amount of about 0.05 percent to about 6.0 percent by weight of the nanoparticle gel system. For example, the nanoparticle-size clay may be present in an amount of about 0.1 percent to about 5.0 percent by weight of the nanoparticle gel system. According to several exemplary embodiments, the nanoparticle-size clay includes one or more smectite clays. According to several exemplary embodiments, the smectite clays include hectorite.

According to several exemplary embodiments, the nanoparticle gel system further includes an aqueous fluid. According to several exemplary embodiments, the nanoparticle gel system is thermally stable up to a temperature of about 400° F.

According to several exemplary embodiments, the method further includes recovering hydrocarbons from the carbonate formation.

According to several exemplary embodiments, another method of treating a carbonate formation is provided. The method includes introducing a nanoparticle gel system including a gelling agent, a nanoparticle-size clay and a proppant into the carbonate formation at a rate and pressure sufficient to create or enhance at least one fracture in the carbonate formation; allowing a portion of the proppant to deposit in the at least one fracture; pumping hydrochloric acid, acetic acid, or both into the carbonate formation; and allowing a portion of the hydrochloric acid, acetic acid, or both to at least partially reduce a viscosity of the nanoparticle gel system and to create conductive channels in the carbonate formation. Other suitable acids include formic acid, hydroxycarboxylic (mono, di and tri-carboxylic) acids such as glycolic, lactic, malonic, succinic, gluconic, and citric acids, and certain chelating agents of the aminopolycarboxylic acid type that are sufficiently soluble in low pH media such as methylglycine N,N-diacetic acid (MGDA), glutamic acid N,N-diacetic acid (GLDA), nitrilotriacetic acid (NTA), N-(hydroxyethyl)-ethylenediaminetriacetic acid (HEDTA), hydroxyethyliminodiacetic acid (HEIDA), and those described in U.S. Publication No. 2014/0287968 and U.S. Pat. No. 9,127,194, which are incorporated by reference herein by express reference thereto.

According to several exemplary embodiments, the nanoparticle gel system further includes a metal cross-linking agent and the gelling agent is cross-linked. According to several exemplary embodiments, the gelling agent includes carboxymethylcellulose. According to several exemplary embodiments, the nanoparticle-size clay includes hectorite. According to several exemplary embodiments, the gelling agent includes carboxymethylcellulose and the nanoparticle-size clay includes hectorite.

According to several exemplary embodiments, the nanoparticle gel system is thermally stable up to a temperature of about 400° F.

According to several exemplary embodiments, yet another method of treating a carbonate formation is provided. The method includes introducing a nanoparticle gel system including cross-linked carboxymethylcellulose, hectorite, and a proppant into the carbonate formation at a rate and pressure sufficient to create or enhance at least one fracture in the carbonate formation; allowing a portion of the proppant to deposit in the at least one fracture; pumping an acidic fluid into the carbonate formation; and allowing a portion of the acidic fluid to at least partially reduce a viscosity of the nanoparticle gel system and to create conductive channels in the carbonate formation.

According to several exemplary embodiments, the nanoparticle gel system is thermally stable up to a temperature of about 400° F.

As used herein, “treat,” “treatment,” and “treating” refer to any subterranean operation that uses a fluid in conjunction with achieving a desired function and/or for a desired purpose. More specific examples of treatment operations include drilling operations, fracturing operations, gravel packing operations, acidizing operations, sand control operations, and consolidation operations.

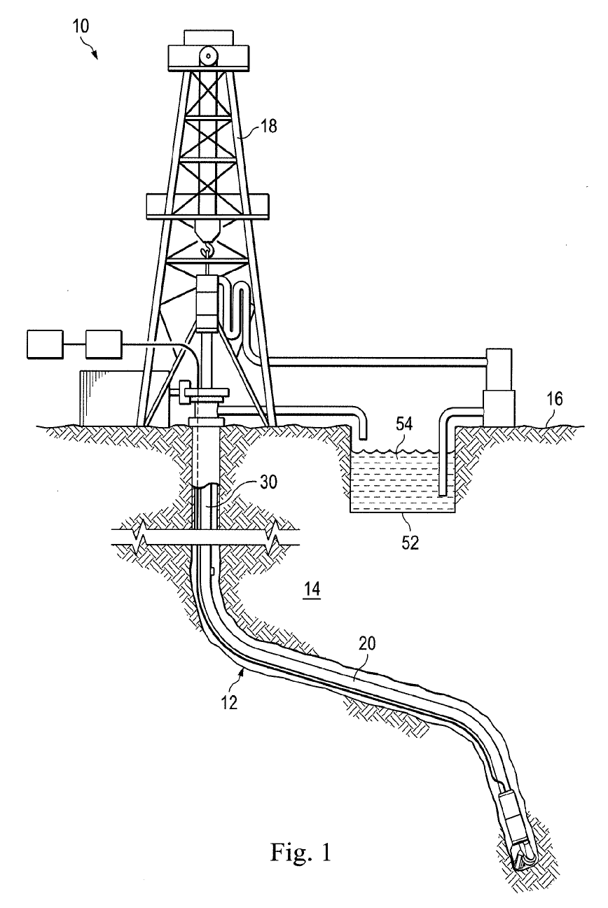

Turning to FIG. 1, shown is an elevation view in partial cross-section of a wellbore drilling and production system 10 utilized to produce hydrocarbons from wellbore 12 extending through various earth strata in an oil and gas formation 14 located below the earth's surface 16. Drilling and production system 10 may include a drilling rig or derrick 18 to perform various activities related to drilling or production, such as the methods described below. Likewise, drilling and production system 10 may include various types of tools or equipment 20 supported by rig 18 and disposed in wellbore 12 for performing these activities.

A working or service fluid source 52, such as a storage tank or vessel, may supply a working fluid 54 that is pumped to the upper end of tubing string 30 and flows through tubing string 30. Working fluid source 52 may supply any fluid utilized in wellbore operations, including without limitation, drilling fluid, slurry, acidizing fluid (e.g., hydrochloric acid, acetic acid, etc.), liquid water, steam, hydraulic fracturing fluid, propane, nitrogen, carbon dioxide or some other type of fluid.

According to several exemplary embodiments, a method of treating a carbonate formation includes using a nanoparticle gel system that provides fracture control and functions as a proppant-delivery composition. According to several exemplary embodiments, the nanoparticle gel system includes an aqueous fluid, a gelling agent, a cross-linking agent, a nanoparticle-size clay, and a proppant.

According to several exemplary embodiments, the aqueous fluid includes, for example, fresh water. Aqueous fluids can be obtained from any suitable source. The aqueous fluid may include any additives that may be necessary for the fluid to perform the desired function or task, provided that these additives do not negatively interact with the gelling agent, the nanoparticle-size clay, or the proppant. Such additives may include gel stabilizers, pH-adjusting agents, corrosion inhibitors, dispersants, flocculants, acids, foaming agents, antifoaming agents, H₂S scavengers, lubricants, particulates (e.g., gravel), bridging agents, weighting agents, scale inhibitors, biocides, and friction reducers. Suitable additives for a given application will be known to those of ordinary skill in the art.

According to several exemplary embodiments, the gelling agent includes any suitable polymer that can impart the desired viscosity to the fracturing fluid and that is generally soluble in an aqueous fluid. Any of a variety of gelling agents can be utilized in the methods of the present invention. For example, the gelling agent may include one or more cellulose derivatives such as hydroxyethylcellulose (HEC), carboxymethylcellulose (CMC), and carboxymethylhydroxyethylcellulose (CMHEC); substituted and unsubstituted galactomannans including guar gum and guar derivatives; starch derivatives; gums including ghatti, Arabic, tragacanth, locust bean, karaya, carrageenan, algin, and derivatives of such gums; biopolymers; and mixtures thereof. Suitable gelling agents include, but are not limited to, guar gum?, hydroxypropylguar (HPG), carboxymethylguar (CMG) carboxymethylhydroxypropylguar (CMHPG), xanthan gum, and succinoglycan. According to several exemplary embodiments, the gelling agent includes CMC. The gelling agent is generally present in the nanoparticle gel system in an amount in the range of from about 0.1 percent to about 1.2 percent by weight of the nanoparticle gel system.

According to several exemplary embodiments, the gelling agent is cross-linked, and the cross-linking agent includes any suitable cross-linking agent that is capable of crosslinking at least two gelling agent molecules to increase the molecular weight of the gelling agent and increase the viscosity of the nanoparticle gel system. Examples of suitable cross-linking agents include the salts or complexes of the multivalent metals such as chromium, zirconium, titanium and aluminum. These cross-linking agents bond ionically with the gelling agent to form the cross-linked molecule. Other suitable cross-linking agents include boron-releasing cross-linking compounds, such as borax, boric acid, sparingly-soluble borates, or combinations thereof. The amount of cross-linking agent used will typically vary depending upon the type of gelling agent and the degree of cross-linking desired.

According to several exemplary embodiments, the nanoparticle-size clay is any suitable clay that imparts static stability to the nanoparticle gel system. According to several exemplary embodiments, the nanoparticle-size clay functions as a fluid loss agent and/or a propping agent. According to several exemplary embodiments, the nanoparticle-size clay increases the viscosity of the nanoparticle gel system. Suitable clays include synthetic clays and organophilic clays. Examples include laponite; beidellite; smectite clays such as hectorite, montmorillonite, saponite, bentonite, nontronite, and sauconite; palygorskite clays (magnesium aluminum phyllosilicates) such as sepiolite and attapulgite; kaolin clays such as kaolinite, nacrite, dickite, and halloysite; hydrousmica clays such as hydrobiotite, glauconite, illite and bramallite; and chlorite clays such as chlorite and chamosite. According to several exemplary embodiments, the nanoparticle-size clay includes hectorite. The nanoparticle-size clay is generally included in the nanoparticle gel system in an amount in the range of from about 0.2 percent to about 4.0 percent by weight of the nanoparticle gel system, alternatively from about 0.05 percent to 8 percent by weight of the nanoparticle gel system. In several exemplary embodiments, the nanoparticle-size clay is present in an amount of about 1.0 to about 5.0 percent by weight of the nanoparticle gel system

According to several exemplary embodiments, the proppant is any suitable material that can “prop” or keep a fracture open. Suitable proppant materials can include sand, gravel, glass beads, ceramics, bauxites, and glass, or combinations thereof. In several exemplary embodiments, the proppant material can be selected from ceramic, silica, muscovite, biotite, limestone, Portland cement, talc, kaolin, barite, fly ash, pozzolan, alumina, zirconia, titanium oxide, zeolite, graphite, carbon black, aluminosilicates, biopolymer solids, and synthetic polymer solids, including combinations and mixtures thereof. Thus, various proppant materials like plastic beads such as styrene divinylbenzene, and particulate metals may be used. Other proppant materials may be materials such as drill cuttings that are circulated out of the well. Also, naturally occurring particulate materials may be used as proppants, including, but not necessarily limited to: ground or crushed shells of nuts such as walnut, coconut, pecan, almond, ivory nut, and brazil nut; ground or crushed seed shells (including fruit pits) of seeds of fruits such as plum, olive, peach, cherry, and apricot; ground or crushed seed shells of other plants such as maize (e.g., corn cobs or corn kernels); processed wood materials such as those derived from woods such as oak, hickory, walnut, poplar, and mahogany, including such woods that have been processed by grinding, chipping, or other form of comminution and processing, some nonlimiting examples of which are proppants made of walnut hulls impregnated and encapsulated with resins. Resin coated (various resin and plastic coatings) or encapsulated proppants having a base of any of the previously listed propping materials such as sand, ceramics, bauxite, and nut shells may be used in accordance with several exemplary embodiments of the present invention.

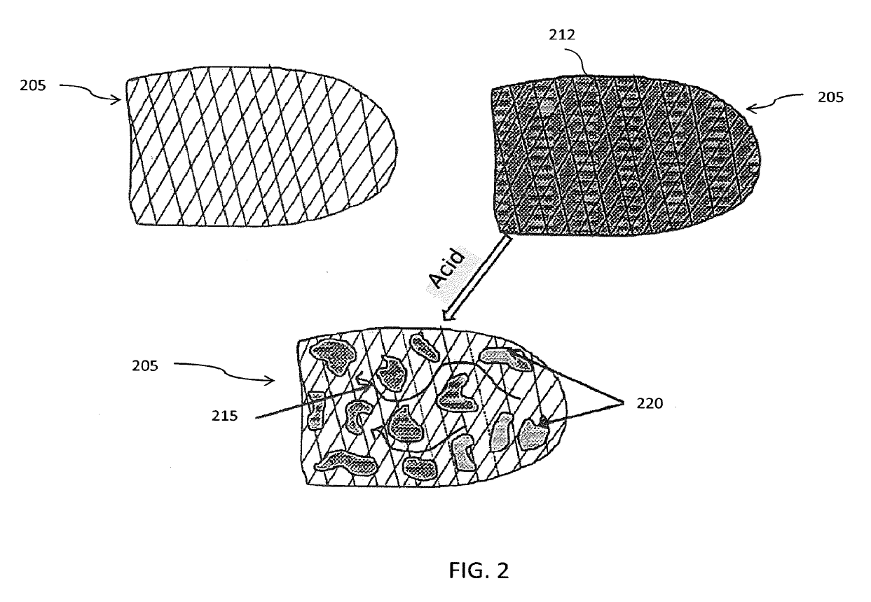

Referring to FIG. 2, a carbonate formation or reservoir is shown before and after it is treated with the nanoparticle gel system. First, the nanoparticle gel system is introduced into the carbonate formation 205 to fracture the formation 205 and form a film 212 on the formation 205. According to several exemplary embodiments, the nanoparticle gel system is pumped down a wellbore at a rate and pressure sufficient to form fractures in the formation, providing pathways through which oil and gas can flow. To maintain the fractures open when the fracturing pressures are removed, proppant in the nanoparticle gel system is carried into the fractures.

Second, an acidic fluid is introduced into the formation 205. The acidic fluid functions to dissolve acid soluble materials in the formation 205 so as to increase the permeability of the formation 205. The permeability increase is brought about by cleaning or enlarging flow channels leading to the wellbore, which allows more oil or gas to flow to the wellbore. In the present invention, the acidic fluid breaks up or reduces the viscosity of the nanoparticle gel system and dissolves the formation 205 to create open channels 215 in the formation 205, leaving proppant and/or nanoparticle-size clay clusters 220 in the fractured formation 210. Suitable acidic fluids include, but are not limited to, hydrochloric acid, citric acid, acetic acid, formic acid, hydrofluoric acid, and mixtures thereof. Other suitable acidic fluids include salts of hydrochloric acid (HCl) such as urea*HCl, glycine*HCl, and amino-hydrochloride salts.

Advantageously, the nanoparticle gel system exhibits: (1) thermal stability up to about 400° F., which is typically necessary for fracturing high temperature reservoirs, (2) breaking or de-viscosification by an acidic or low pH fluid (e.g., pH of less than about 4.5), (3) fluid loss control properties, and (4) diverting fluid properties. The nanoparticle gel system provides exceptional temperature stability.

Moreover, in several exemplary embodiments, the nanoparticle gel system is capable of carrying or suspending a proppant at high temperatures and shear rates. According to several exemplary embodiments, use of the nanoparticle gel system enhances reservoir clean up and minimizes formation damage. In addition, submicron sized particulates (e.g., the nanoparticle-size clay) may be used in low to ultralow permeability formations, where the use of conventionally sized proppant is limited to placement in the main fracture, but cannot be placed in induced or sub-millimeter fractures.

According to several exemplary embodiments, the nanoparticle gel system includes a metal or borate cross-linker to improve dynamic proppant transport. According to several exemplary embodiments, comparable results can be obtained by increasing the concentration of the nanoparticle-size clay. Thus, in several exemplary embodiments, a cross-linker is not required to confer high temperature stability to the nanoparticle gel system. According to several exemplary embodiments, the nanoparticle gel system provides several advantages over conventional guar-borate and metal cross-linked systems. Table 1 summarizes some of these advantages.

TABLE 1
Comparison of Nanoparticle Gel System with
Guar-Borate and Metal Cross-linked System

| | | | | | Elasticity |
|---|---|---|---|---|---|
| | | | | | of the |
| | | | | | System |
| | | Shear | | | under |
| | Thermal | Re- | Clean- | Salt | Low |
| Fluid System | Stability | Healing | Up | Tolerance | Shear |
| Nanoparticle | Up to about | X | X | — | high |
| Gel System | 400° F. | | | | |
| Metal Cross- | Up to about | — | X | — | medium |
| Linked | 275° F. | | | | |
| System | | | | | |
| Guar-Borate | Up to about | X | X | X | low |
| Cross-Linked | 250° F. | | | | |
| System | | | | | |

As shown in the table above, the nanoparticle gel system is a thermally stable elastic system compared to the guar-borate and metal cross-linked systems.

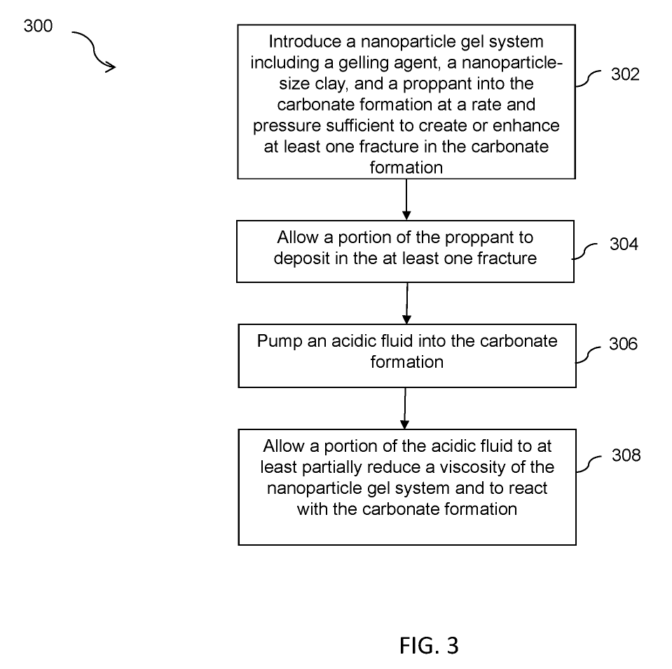

According to several exemplary embodiments, a method of treating a carbonate formation is provided. Turning now to FIG. 3, the method 300 includes introducing a nanoparticle gel system including a gelling agent, a nanoparticle-size clay, and a proppant into the carbonate formation at a rate and pressure sufficient to create or enhance at least one fracture in the carbonate formation in step 302, allowing a portion of the proppant to deposit in the at least one fracture in step 304, pumping an acidic fluid into the carbonate formation in step 306, and allowing a portion of the acidic fluid to at least partially reduce a viscosity of the nanoparticle gel system and to create conductive channels in the carbonate formation in step 308. The term “introducing,” as used herein, includes pumping, injecting, pouring, releasing, displacing, spotting, circulating, or otherwise placing a fluid or material within a well, wellbore, or subterranean formation using any suitable manner known in the art.

The following examples are illustrative of the compositions and methods discussed above and are not intended to be limiting.

### Example 1

Thermal Stability

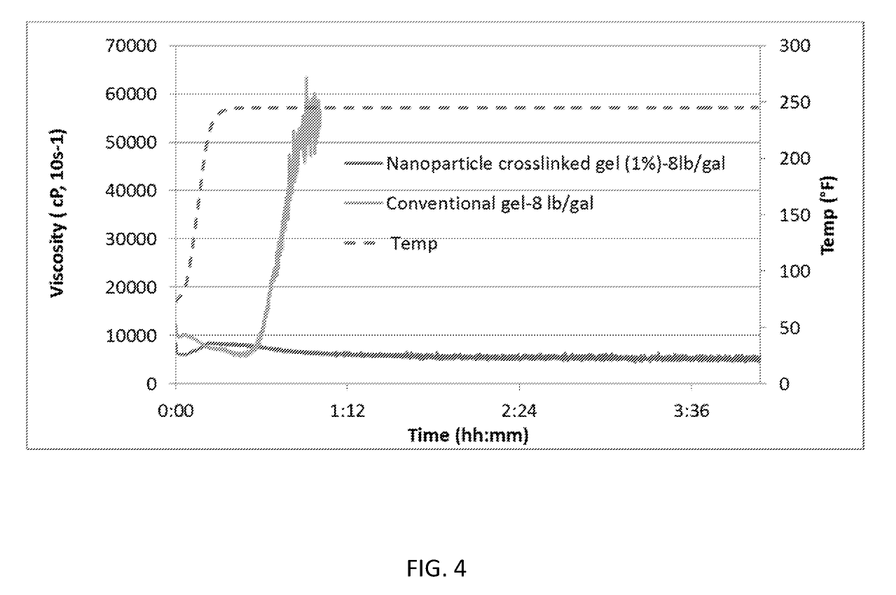

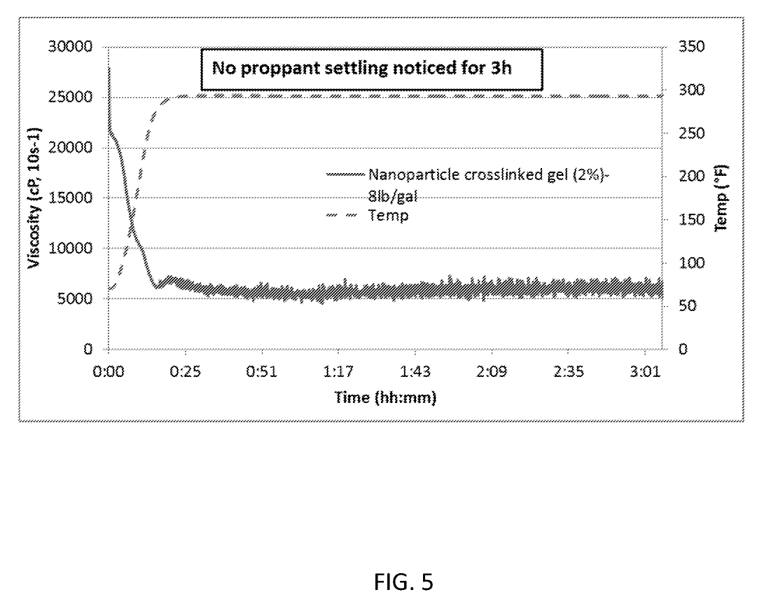

To understand temperature stability of the nanoparticle gel system, proppant suspension and transportability were tested using a mimic device. Two nanoparticle gel systems containing: (1) 1% hectorite by weight, 40 pounds/1000 gallons CMC and 8 pounds per gallon of sand or (2) 2% hectorite by weight, 40 pounds/1000 gallons CMC and 8 pounds per gallon of proppant were tested at 250° F. and 300° F. respectively. The CMC was hydrated followed by the addition of the hectorite under shear, and the mixture was hydrated for 20 minutes. The sand was added to the gel containing CMC and hectorite. The proppant laden slurry was transferred to mimic device cubicle and viscosity was measured at test temperature. The results are provided in FIGS. 4 and 5.

Referring to FIGS. 4 and 5, a sharp increase in viscosity represents proppant settling when the mimic device was used. No proppant settling was observed in the 1% hectorite system at about 4 hours at 250° F. in FIG. 4 and in the 2% hectorite system at about 3 hours at 300° F. in FIG. 5, whereas the conventional gel system showed a sharp increase in viscosity after 45 minutes at 250° F., which suggested proppant settling. No proppant settling was observed in the 2% hectorite system even after 3 hours at 300° F. These tests confirm that nanoparticle-size clay can be used without any cross-linker to provide proppant transport, even at elevated temperatures.

### Example 2

Gel Break in Acidic Fluid

It was observed that the gel filter cake of the nanoparticle gel system was easily broken in the presence of acidic fluids. To confirm this property, a filter cake was built by mixing 150 L of Houston tap water with 720 grams of WG-39 grade guar gum. One thousand one hundred twenty five (1125) grams of hectorite was then added to the fluid reservoir and its pH adjusted using BA-20™ buffering agent. Subsequently, CL-23™ cross-linking agent was added at the centrifugal point at a concentration of 0.5 grams per ton (gpt) and a rate of 0.65 mL/min. Fluid loss was run at 120° F. with a flow rate maintained at 1.3 L/min for 1 hour. After the test, the cells were disassembled, and the filter cake was collected from each of the cores. Four (4) grams of filter cake was immersed in about 6% hydrochloric acid solution for a period of 24 hours at 200° F. Complete filter cake dissolution was observed.

In another experiment, BA-20™ buffering agent was used to break the gel in the filter cake, resulting in a slower break. Approximately 50% weight loss was observed after 24 hours and complete dissolution was observed after 48 hours.

In a separate set of experiments, equal amounts of nanoparticle-size clay particles were immersed in acid (a 7% hydrochloric acid solution and an acetic acid solution) and water. Instant gelation was observed in the water, whereas nanoparticle swelling in each of the hydrochloric acid solution and the acetic acid solution did not occur, indicating that in acidic systems, swelling of nanoparticles can be controlled, leading to gel break.

### Example 3

Hectorite vs. Bentonite and Kaolin

The ability of different nanoparticle-size clays to provide stability to proppant was tested. Hectorite, bentonite, and kaolin were tested at concentrations of about 2% by weight of a test fluid (water). The 2% hectorite supported 2 pounds/gallon proppant, whereas the proppant settled to the bottom in the 2% bentonite and 2% kaolin test fluids.

### Example 4

Synergy of Hectorite Clay with CMC and Guar Gum

The viscosity of 40 lb/1000 gal CMC was measured to be about 20 cP and the viscosity of 1% by weight hectorite in water was measured to be about 4 cP at room temperature. As can be seen from Table 2 below, the combination of the CMC and hectorite increased viscosity to about 76 cP at 511 s⁻¹. The viscosity of 20 lb/1000 gal guar gum was measured to be about 16 cP. The combination of the guar gum and hectorite increased the viscosity to about 25 cP at 511 s⁻¹, which is an improvement. In both cases, improved gel viscosity was observed after heating. Viscosity increased in the CMC sample to 110 cP and increased in the guar gum sample to 32 cP.

TABLE 2
Synergy of Hectorite with CMC and Guar Gum

| | Gel viscosity (511 s⁻¹, | |
|---|---|---|
| | 23° C./after heating at | |
| Sample description | 200° F.) | Observation |
| 0.75% w/v hectorite clay | 2 cP/12 cP | Weak gel |
| in water | | |
| 1.0% w/v hectorite clay in | 4 cP/17 cP | Weak gel |
| water | | |
| 40 lb/1000 gal CMC | 20 cP at room | Linear gel |
| | temperature | |
| 40 lb/1000 gal CMC + 1% | 76 cP/110 cP | Thick gel |
| hectorite | | |
| 20 lb/1000 gal Guar Gum | 16 cP at room | Linear gel |
| | temperature | |
| 20 lb/1000 gal Guar Gum + | 25 cP/32 cP | Thick gel |
| 1% hectorite | | |

According to several exemplary embodiments, the nanoparticle gel system provides exceptional temperature stability, and properly formulated, even a guar based fluid can be used to lower the cost of service. Advantageously, the nanoparticle gel system displays good elastic properties under low shear, which is necessary for static proppant support, provides a differentiating solution for high temperature fracturing and acidizing markets, and offers enhanced vertical proppant suspension, which conventional fluid does not.

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

What is claimed is:

1. A method of treating a carbonate formation comprising:
introducing a nanoparticle gel system comprising a gelling agent, a nanoparticle-size clay, and a proppant into the carbonate formation at a rate and pressure sufficient to create or enhance at least one fracture in the carbonate formation;
allowing a portion of the proppant to deposit in the at least one fracture;
pumping an acidic fluid into the carbonate formation; and
allowing a portion of the acidic fluid to at least partially reduce a viscosity of the nanoparticle gel system and to react with the carbonate formation.

2. The method of claim 1, wherein the gelling agent is present in the nanoparticle gel system in an amount of about 0.1 percent to about 2.0 percent by weight of the nanoparticle gel system.

3. The method of claim 1, wherein the nanoparticle-size clay is present in the nanoparticle gel system in an amount of about 0.05 percent to about 6.0 percent by weight of the nanoparticle gel system.

4. The method of claim 1, wherein the nanoparticle gel system further comprises a cross-linking agent, and the gelling agent is cross-linked.

5. The method of claim 4, wherein the cross-linking agent comprises a metal cross-linking agent.

6. The method of claim 1, wherein the nanoparticle gel system further comprises an aqueous fluid.

7. The method of claim 1, wherein the gelling agent comprises one or more cellulose derivatives, guar gum, or guar derivatives.

8. The method of claim 7, wherein the cellulose derivatives comprise carboxymethylcellulose.

9. The method of claim 1, wherein the nanoparticle-size clay comprises one or more smectite clays.

10. The method of claim 9, wherein the smectite clays comprise hectorite.

11. The method of claim 1, wherein the nanoparticle gel system is thermally stable up to a temperature of about 400° F.

12. The method of claim 1, further comprising recovering hydrocarbons from the carbonate formation.

13. The method of claim 1, wherein a pump is used to introduce the nanoparticle gel system into the carbonate formation.

14. A method of treating a carbonate formation comprising:
introducing a nanoparticle gel system comprising a gelling agent, a nanoparticle-size clay and a proppant into the carbonate formation at a rate and pressure sufficient to create or enhance at least one fracture in the carbonate formation;
allowing a portion of the proppant to deposit in the at least one fracture;
pumping hydrochloric acid, acetic acid, or a hydrochloric acid/acetic acid mixture into the carbonate formation; and
allowing a portion of the hydrochloric acid, acetic acid, or both to at least partially reduce a viscosity of the nanoparticle gel system and to react with the carbonate formation.

15. The method of claim 14, wherein the nanoparticle gel system further comprises a metal cross-linking agent, and the gelling agent is cross-linked.

16. The method of claim 14, wherein the gelling agent comprises carboxymethylcellulose.

17. The method of claim 14, wherein the nanoparticle-size clay comprises hectorite.

18. The method of claim 14, wherein the nanoparticle gel system is thermally stable up to a temperature of about 400° F.

19. A method of treating a carbonate formation comprising:
introducing a nanoparticle gel system comprising cross-linked carboxymethylcellulose, hectorite, and a proppant into the carbonate formation at a rate and pressure sufficient to create or enhance at least one fracture in the carbonate formation;
allowing a portion of the proppant to deposit in the at least one fracture;
pumping an acidic fluid into the carbonate formation; and
allowing a portion of the acidic fluid to at least partially reduce a viscosity of the nanoparticle gel system and to react with the carbonate formation.

20. The method of claim 19, wherein the nanoparticle gel system is thermally stable up to a temperature of about 400° F.
